(19) United States
(12) Patent Application Publication
(10) Pub. No.: US 2026/0104912 A1
(43) Pub. Date: Apr. 16, 2026

(54) METADATA-DRIVEN INTERRUPT MANAGEMENT IN A DATA TRANSFORM ACCELERATOR

(71) Applicant: MAXLINEAR, INC., Carlsbad, CA (US)

(72) Inventor: Pinaki Shankar Chanda, San Diego, CA (US)

(73) Assignee: MAXLINEAR, INC., Carlsbad, CA (US)

(21) Appl. No.: 19/359,634

(22) Filed: Oct. 15, 2025

Related U.S. Application Data
(60) Provisional application No. 63/707,611, filed on Oct. 15, 2024.

(51) Int. Cl. G06F 9/48

(52) U.S. Cl. CPC G06F 9/4812

(57) ABSTRACT

A method may include determining characteristics associated with a host device and a data transform accelerator. The method may also include adjusting a command field for interrupt management in a command to be transmitted from the host device to the data transform accelerator, which may be based on the characteristics. The method may further include obtaining transformed data from the data transform accelerator based on the command.

### CROSS REFERENCE TO RELATED APPLICATIONS

This U.S. patent application claims priority to U.S. Provisional Patent Application No. 63/707,611, titled “INTERRUPT RATE CONTROL IN A DATA TRANSFORM ACCELERATOR,” and filed on Oct. 15, 2024, the disclosure of which is hereby incorporated by reference in its entirety.

### TECHNICAL FIELD

This disclosure generally relates to data transform acceleration, and more specifically, to metadata-driven interrupt management in a data transform accelerator.

### BACKGROUND

Unless otherwise indicated herein, the materials described herein are not prior art to the claims in the present application and are not admitted to be prior art by inclusion in this section.

Data transform accelerators are co-processor devices that are used to accelerate data transform operations for various applications such as data analytics applications, big data applications, storage applications, cryptographic applications, and networking applications. For example, a data transform accelerator can be configured as a storage accelerator and/or a cryptographic accelerator.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include determining characteristics associated with a host device and a data transform accelerator. The method may also include adjusting a command field for interrupt management in a command to be transmitted from the host device to the data transform accelerator, which may be based on the characteristics. The method may further include obtaining transformed data from the data transform accelerator based on the command.

In another embodiment, a system may include a data transform accelerator and a host device. The host device may be in communication with the data transform accelerator. The host device may be configured to determine characteristics associated with the host device and the data transform accelerator. The host device may also be configured to adjust a command field for interrupt management in a command to be transmitted from the host device to the data transform accelerator, which may be based on the characteristics. The host device may further be configured to obtain transformed data from the data transform accelerator based on the command.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for metadata-driven interrupt management in a data transform accelerator;

FIG. 2 illustrates a block diagram of an example system including a CPU used for metadata-driven interrupt management in a data transform accelerator;

FIG. 3 illustrates a block diagram of an example system utilizing commands for metadata-driven interrupt management in a data transform accelerator;

FIG. 4 illustrates a flowchart of an example method for metadata-driven interrupt management in a data transform accelerator; and

FIG. 5 illustrates an example computing device.

### DETAILED DESCRIPTION

A data transform accelerator may be used as a coprocessor device in conjunction with a host device or server (referred to as host device unless otherwise explicitly stated) to accelerate data transform operations for various applications, such as data analytics, big data, storage, and/or networking applications. The data transform operations may include, but not be limited to, compression, decompression, encryption, decryption, authentication tag generation, authentication, data deduplication, non-volatile memory express (NVMe) protection information (PI) generation, NVMe PI verification, and/or real-time verification. Such data transform accelerators may be connected to the host device using one or more various interface technologies, such as Peripheral Component Interconnect Express (PCIe), Universal Serial Bus (USB), Unified Configuration Interface (UCI), etc.

A data transform accelerator may be operable to perform compression and/or security acceleration with low latency and/or high throughput. Packets transmitted to the data transform accelerator (such as from the host device) for transformation may be initially stored in a ring or container associated with the data transform accelerator. In some instances, once transform operations are completed, the data transform accelerator may generate an interrupt (e.g., a “command done” interrupt) that may be used to notify the host device that the transformation is complete. In some instances, the interrupt may be transmitted from the data transform accelerator to the host device using the interface (e.g., PCIe) as a message signaled interrupt (MSI)-X interrupt. In such instances, interrupts from the data transform accelerator may be masked and/or unmasked (e.g., a form of throttling), which may be an inefficient method for handling interrupts.

For example, in some instances, interrupt throttling may be performed by an interrupt module that manages the interrupts in the system. Alternatively, or additionally, the interrupt module may perform interrupt throttling in a reactive manner, or in instances in which the interrupt module has access to partial information associated with the interrupt and/or with the data transform accelerator. In some instances, applications, hardware/software modules, and/or other devices (referred to generally as a command device) that may be operable to submit commands to the data transform accelerator may have (or have access to) information associated with the data transform accelerator and/or the workload to be performed by the data transform accelerator. In such instances, the command device may utilize the information about the data transform accelerator and/or the workload of the data transform accelerator to improve the interrupt rate control.

In at least some aspects of the present disclosure, an interrupt management process may be implemented where the occurrence of interrupts in a data transform accelerator may be managed by commands submitted to the data transform accelerator from a command device. In some instances, the command device may be configured to set a field in the command (e.g., at least a portion of metadata included in the command) to provide instructions to the data transform accelerator regarding interrupt control therein. As described, the interrupt control management may be performed by the command device on a per command basis, such that consideration of the data transform accelerator and/or the workload associated with the data transform accelerator may be used in implementing interrupt rate control in the data transform accelerator.

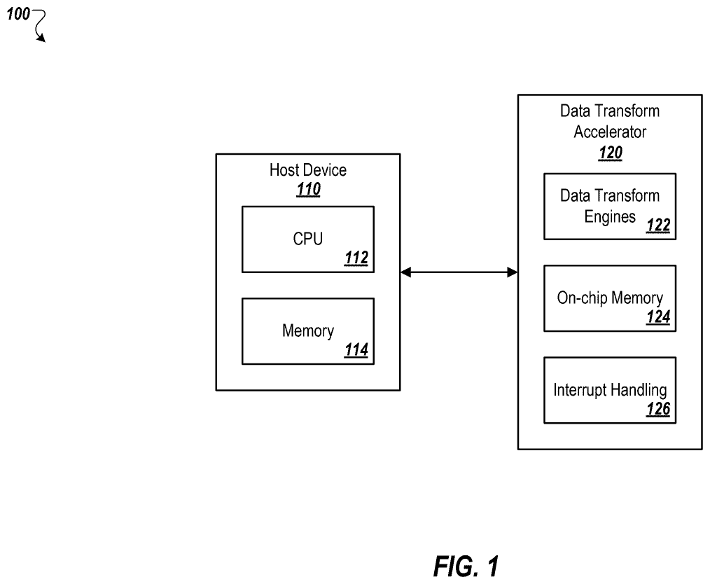

FIG. 1 illustrates a block diagram of an example system 100 for metadata-driven interrupt management in a data transform accelerator. The system 100 may include a host device 110, and a data transform accelerator 120. The host device 110 may be include a CPU 112 and memory 114. The data transform accelerator 120 may include data transform engines 122, on-chip memory 124, and an interrupt handling module 126.

The host device 110 may be a computer, server, and/or other computing device that may be in communication with the data transform accelerator 120. In some instances, the host device 110 may utilize a data communication interface (e.g., a Peripheral Component Interconnect express (PCIe) interface, a Universal Serial Bus (USB) interface, and/or other similar data communication interfaces) to communicate with the data transform accelerator 120.

In some instances, the data transform accelerator 120 may include the data transform engines 122 as compute resources. Algorithm accelerations may be provided by the data transform engines 122. Algorithm accelerations could be data transform operations such as compression, decompression, encryption, decryption, authentication tag generation and verification, data deduplication, NVMe protection information generation and verification, and/or real-time verification. The data transform engines 122 may be operable to perform operations in a parallel manner.

The data transform engines 122 can be connected in a pipeline in the data transform accelerator 120. In some instances, there may be more than one pipeline that may be configured to operate in parallel with other pipelines. The pipelines in the data transform accelerator 120 could be in an encode direction and/or in a decode direction. In some instances, there can be more than one bank of transform engines 122 in the data transform accelerator 120. For example, a first bank of data transform engines 122 may be for both encode operations and decode operations and a second bank of data transform engines 122 may be for only decode operations.

The host device 110 may submit commands to the data transform accelerator 120, as well as source data to be transformed and/or addresses of output buffers configured to hold the transformed data. The host device 110 may also provide control information and/or metadata that describes specific algorithmic transformation to be applied on the source data. A command may include of a set of source data descriptors and a set of destination data descriptors. The input data buffers may be described by the source data descriptors and the output buffers may be described by the destination data descriptors. At least some of the source buffer descriptors may point to one or more input data buffers that may contain metadata and/or control information that may describe the transformation algorithms and/or how the source data may be transformed. In some instances, a set of containers may be created in the memory 114 of the host device 110 and/or in the on-chip memory 124 of the data transform accelerator 120 to hold the addresses of the commands.

In some instances, system 100 may implement adaptively changing interrupt rates on a per command basis. As such, interrupt metadata within the commands may direct the data transform accelerator 120 as to when an interrupt may be scheduled, which may improve efficiency of the system 100 (including the host device 110 and/or the data transform accelerator 120). In some instances, the interrupt metadata may be based on a workload of the data transform accelerator 120 and/or bottlenecks that may be present in the host device 110, the data transform accelerator 120, and/or other elements of the system 100. In these and other instances, the system 100 described herein may be applicable to any data transform or data processing devices that may be implemented in an embedded processor, ASIC, FPGA, software-hardware integration, host computer, and/or any other device that may be used for interrupts signaling a completion of data processing operations.

Based on the metadata, the data transform engines 122 may perform operations on the source data. Once the operations are complete, the transformed data may be returned to the host device 110 via the output buffers. On completion of the operation, the data transform accelerator 120 may signal the CPU in the host device 110 by using an interrupt for the command.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

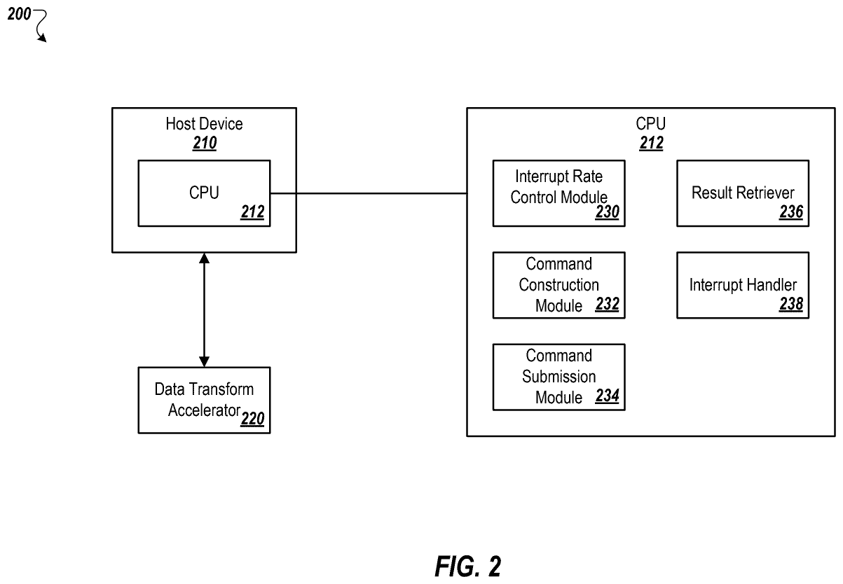

FIG. 2 illustrates a block diagram of an example system 200 including a CPU used for metadata-driven interrupt management in a data transform accelerator. The system 200 may include a host device 210 and a data transform accelerator 220. The host device 210 may include a CPU 212, which may include an interrupt rate control module 230, command construction module 232, command submission module 234, a result retriever 236, and an interrupt handler 238. In some instances, the host device 210 and the data transform accelerator 220 may be the same or similar as the host device 110 and the data transform accelerator 120, respectively, of FIG. 1.

In some instances, interrupt rate control may be implemented using the interrupt rate control module 230 in the host device 210, which may be operated by the CPU 212. The interrupt rate control module 230 may be operable to determine characteristics associated with the host device 210 and/or the data transform accelerator 220 and may determine instances in which interrupt management may be implemented in the data transform accelerator 220 via metadata in the command. The command construction module 232 may be operable to generate a command to be submitted to the data transform accelerator 220 and the command submission module 234 may be operable to submit the command from the host device 210 to the data transform accelerator 220. The result retriever 236 may be operable to obtain transformed results from the data transform accelerator 220 and the interrupt handler 238 may be operable to evaluate the transformed results to determine if interrupt handling may be enabled and if so, the interrupt handler 238 may manage the results based on the interrupt.

Alternatively, or additionally, interrupt rate control may be implemented using the interrupt rate control module 230 in a virtualization environment (e.g., in a guest operating system) within the host device 210. In virtualization, the command device (e.g., one or more of the interrupt rate control module 230, the command construction module 232, the command submission module 234, the result retriever 236, and/or the interrupt handler 238) may be disposed in the guest operating system of the virtual machine and the command device may be operable to submit commands to the data transform accelerator 220, such as via the command submission module 234. The interrupt rate control module 230 may be operable to set the interrupt enable field in the command (e.g., via direction of the command construction module 232 to generate a command with the interrupt enable field set) which may enable interrupt generation from the data transform accelerator 220. In some instances, isolation between command devices running across virtual machines may be maintained as the commands may carry independent control to generate an interrupt from different command devices running on guest operating systems in different virtual machines and no global interrupt throttling field or value is getting programmed to the data transform accelerator 220.

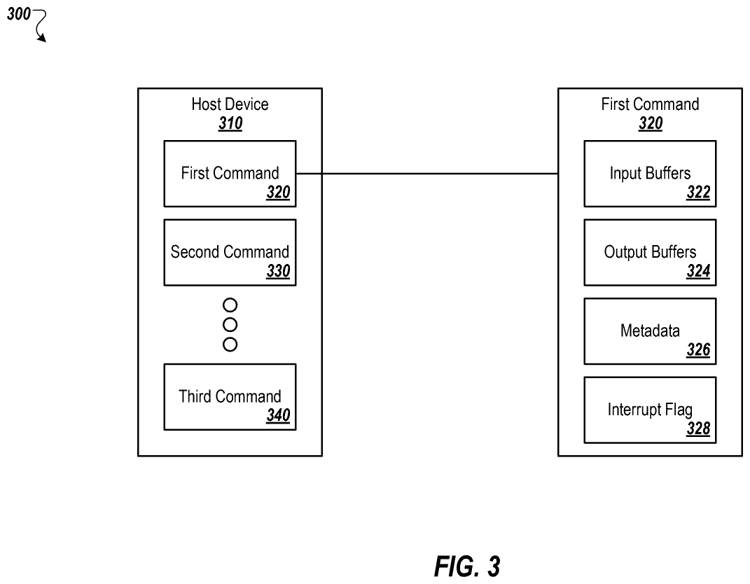

FIG. 3 illustrates a block diagram of an example system 300 utilizing commands for metadata-driven interrupt management in a data transform accelerator. The system 300 may include a host device 310. The host device 310 may include a first command 320, a second command 330, and a third command 340. The first command 320 may include input buffers 322, output buffers 324, metadata 326, and an interrupt flag 328. In some instances, the host device 310 may be the same or similar as the host device 110 of FIG. 1.

In some instances, a command submission module, or command device (e.g., as illustrated and described relative to FIG. 2), may be operable to submit commands, such as one or more of the first command 320, the second command 330, and/or the third command 340, from the host device 310 to a data transform accelerator. Alternatively, or additionally, the command device may be operable to determine (independently or from another device associated with the host device 310 and/or the data transform accelerator) characteristics of the data transform accelerator and/or of the host device 310, which may include, but not be limited to, size of data block submitted to the data transform accelerator, complexity of data transform operations, class of service associated with particular commands, sensitivity to latency of the classes of service, a target throughput for the submitted commands (which target throughput may be based on the class of service), and/or metrics associated with a current bottleneck of the system 300 (e.g., number of pending commands in the data transform accelerator, number of commands submitted to the data transform accelerator and not completed, etc.).

In some instances, the described characteristics may be measured and/or may be known to the command device in advance of the commands being submitted to the data transform accelerator. Alternatively, or additionally, the commands may be independently considered for each class of service associated with the commands submitted by the command device. In some instances, the size of data frames may be known by the command device in advance of command submission to the data transform accelerator. Alternatively, or additionally, the size of the data frames may be adaptively estimated, such as by using a sliding window estimation method and/or any other estimation method.

In some instances, storage devices associated with the system or the data transform accelerator may have a limited number of data sizes that may be associated with the submitted commands (which may not include end of file data sizes that may vary in data size). Further, the data sizes may be determined using a source buffer size or a destination buffer size associated with the command.

In instances in which the data size satisfies a threshold, interrupt rate control may not be used in the system 300. The threshold may be determined empirically and/or may be determined for a particular system (e.g., the threshold may vary between systems). For example, for a particular throughput associated with a data transform accelerator having a data transform rate (e.g., in bytes/second), commands that may be submitted for processing large data block sizes may utilize fewer IO operations relative to commands that may be submitted for processing smaller data block sizes, such that fewer interrupts may be used by the data transform accelerator—and interrupt control may not be utilized.

Some commands may belong to a class of service that may be sensitive to latency. For example, the first command 320 may include a decode operation (associated with a read operation) that may be more latency sensitive compared to the second command 330 that may include an encode operation. In some instances, interrupt rate control applied to an operation may increase the latency of the operation as the data transform accelerator may not generate an interrupt for every command. Alternatively, or additionally, software on the host device 310 may use an interrupt to process results from multiple commands. In such an arrangement, the latency of some of the commands may be increased. The command device may be operable to determine the class of operations associated with a command and the command device may choose to disable interrupt rate control for command classes that may be latency sensitive. Alternatively, or additionally, the command device may be operable to enable interrupt rate control for command classes that may not be latency sensitive.

In instances in which the throughput delivered by the system 300 is limited by the maximum throughput offered by the data transform accelerator and/or by the interface width and speed (e.g., generation and number of lanes in case of PCIe interface), interrupt rate control may not be enabled. Alternatively, or additionally, interrupt rate control may be enabled in such scenarios if there is a reason to reduce CPU utilization while maintaining the same or similar throughput and without degradation of the latency associated with processing the commands.

In instances in which the throughput delivered by the system 300 is the same or similar as the target submission rate of the commands from a submission rate-controlled application, interrupt rate control may not be enabled. Alternatively, or additionally, interrupt rate control may be enabled in such scenarios if there is a reason to reduce CPU utilization while maintaining the same or similar throughput and without degradation of the latency associated with processing the commands.

In these and other instances, the command device may be responsible for controlling the rate of the interrupts. As such, the command submission rate may be available and/or determinable and may be used to determine when interrupt rate control may be utilized.

In some instances, a bottleneck of the system 300 for commands belonging to a particular class of service may be determined by observing the number of the pending commands in the containers of the data transform accelerator belonging to the particular class of service. Estimation of the pending commands in the containers may be performed by using an estimation process that may compute an average number of commands in a sliding window. Further, sampling the number of commands in the container may be performed periodically, such as at every Test interval. A number of pending commands at any sampling instance may be represented by n and estimating the value on the epochs of command submission or retrieval may bias the estimation process. An estimate of the number of pending commands may be nest, which may be computed by:

$${η}_{est} = α * {η}_{est} + ( 1 - α ) * η$$

In the equation, α may be determined empirically based on the software platform, the hardware platform, and/or the data transform accelerator. Alternatively, or additionally, different estimation methodologies may be used to determine an average number of pending commands.

Based on the above metrics, in instances in which the command device enables interrupt rate control for a particular class of commands, the command device may be operable to set an interrupt enable field for a first subset of commands (e.g., the first command 320) and may keep the interrupt enable field reset for a second subset of the commands (e.g., the second command 330) belonging to the particular class, in a given time period. In some instances, a proportion of the commands (e.g., of the particular class of service) submitted to the data transform accelerator having the interrupt enable field set relative to the total number of commands belonging to the particular class of service may contribute to determining an amount of interrupt rate control. For example, in instances in which all commands belonging to a particular class of service have the interrupt enable field set, interrupt rate control may not be applied. Alternatively, or additionally, in instances in which all commands belonging to the class of service have the interrupt enable field not set, interrupts may be disabled and software on the host device 310 may use polling to retrieve the result of commands (e.g., outputs from the data transform operations performed by the data transform accelerator).

In some instances, as the command device constructs a command, the command device may determine if interrupt rate control may be implemented and/or an amount of interrupt rate control to be implemented. Whether interrupt rate control is implemented and/or the degree of control may be based on the factors discussed herein. As such, for a particular subset of commands, the command device may construct a command having a command structure including metadata and/or an interrupt enable field set, and the command device may submit to the command to the data transform accelerator. Alternatively, or additionally, for commands not included in the particular subset of commands as described (and belonging to the same class of service), the command device may construct a command having a command structure including metadata and/or the interrupt enable field not set, and the command device may submit to the command to the data transform accelerator.

In some instances, the data transform accelerator may read the command from the container of the commands for each class of service and the data transform accelerator may decode the command (and the metadata) to determine the type of operation to be applied on the source data and/or the location and size of the source data on which the determined operation may be applied. The data transform accelerator may also be operable to decode the interrupt enable field included in the metadata of the command. In instances in which the interrupt enable field is set, on completion of the command, the data transform accelerator may signal the host device using an interrupt. Alternatively, or additionally, in instances in which the interrupt enable field is not set, the data transform accelerator may not notify the host device using an interrupt. In these and other embodiments, the interrupt rate control performed on a per command basis may provide the system with improved granularity relative to other interrupt methodologies.

As described, interrupt rate control may be independently enabled per command and for each class of service included in a workload of the data transform accelerator. In some instances, the software in the host device 310 may be operable to process a result of the command (e.g., output from the data transform accelerator in response to the command) associated with an interrupt in response to receiving an interrupt from the data transform accelerator. Alternatively, or additionally, the software in the host device 310 may be operable to determine whether additional results may be pending for processing for which the data transform accelerator may not have raised interrupts. In some instances, circumstances in which interrupt rate control is implemented, a single interrupt from the data transform accelerator may trigger processing results of one or more commands.

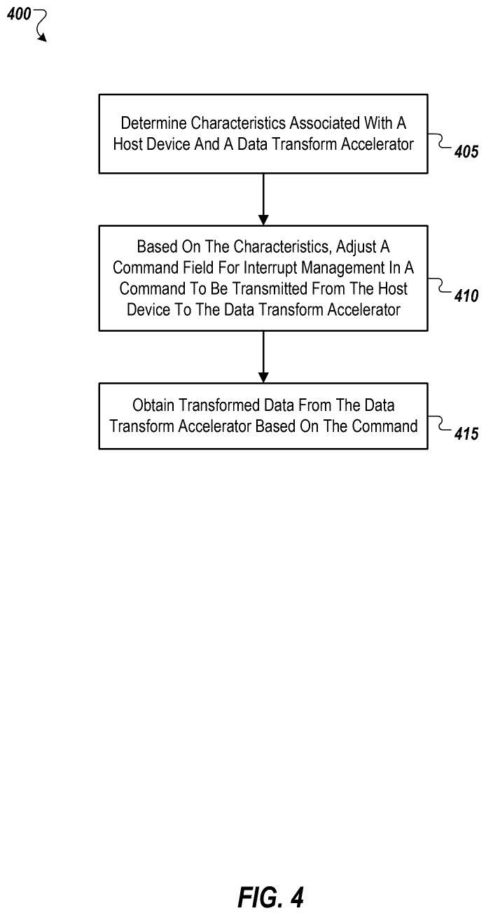

FIG. 4 illustrates a flowchart of an example method 400 for adaptive interrupt management in a data transform accelerator. The method 400 may be performed by processing logic that may include hardware (circuitry, dedicated logic, etc.), software (such as is run on a general purpose computer system or a dedicated machine), or a combination of both, which processing logic may be included in any computer system or device such as the host device 110 and/or the data transform accelerator 120 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method may begin at block 405 where characteristics associated with a host device and a data transform accelerator may be determined. In some instances, the characteristics may include a workload associated with the data transform accelerator.

Alternatively, or additionally, the characteristics may include a state associated with the host device and the data transform accelerator. In some instances, the state may include one or more of a size of data block transmitted to the data transform accelerator, a complexity of data transform operations performed by the data transform accelerator, a class of service associated with the command, a latency sensitivity associated with the class of service, a target throughput for the command, and/or a current bottleneck associated with the host device and the data transform accelerator. In some instances, the current bottleneck may include a number of pending commands in the data transform accelerator, or, in other words, a number of commands submitted to the data transform accelerator that may not yet be completed by the data transform accelerator.

In some instances, the target throughput may be based on the class of service associated with the command. In some instances, the size of the data block may be estimated using a sliding window estimation. Alternatively, or additionally, the size of the data block may be determined based on a source buffer size or a destination buffer size associated with the command. In some instances, the command field may be adjusted to disable the interrupt management in response to the size of the data block satisfying a threshold.

At block 410, a command field for interrupt management in a command may be adjusted. The command may be for transmission from the host device to the data transform accelerator. The command field may be adjusted based on the characteristics. In some instances, the command field may be adjusted to disable the interrupt management in response to a particular characteristic of the characteristics satisfying a threshold. In some instances, the host device may be operable to obtain an interrupt notification prior to the host device obtaining the transformed data from the data transform accelerator in response to the command field being adjusted to be enabled.

At block 415, transformed data may be obtained from the data transform accelerator based on the command.

Modifications, additions, or omissions may be made to the method 400 without departing from the scope of the present disclosure. For example, in some instances, the command field may be adjusted to enable interrupt management for the command and a second command field may be adjusted to not enable interrupt management for a second command. In another example, the designations of different elements in the manner described is meant to help explain concepts described herein and is not limiting. Further, the method 400 may include any number of other elements or may be implemented within other systems or contexts than those described.

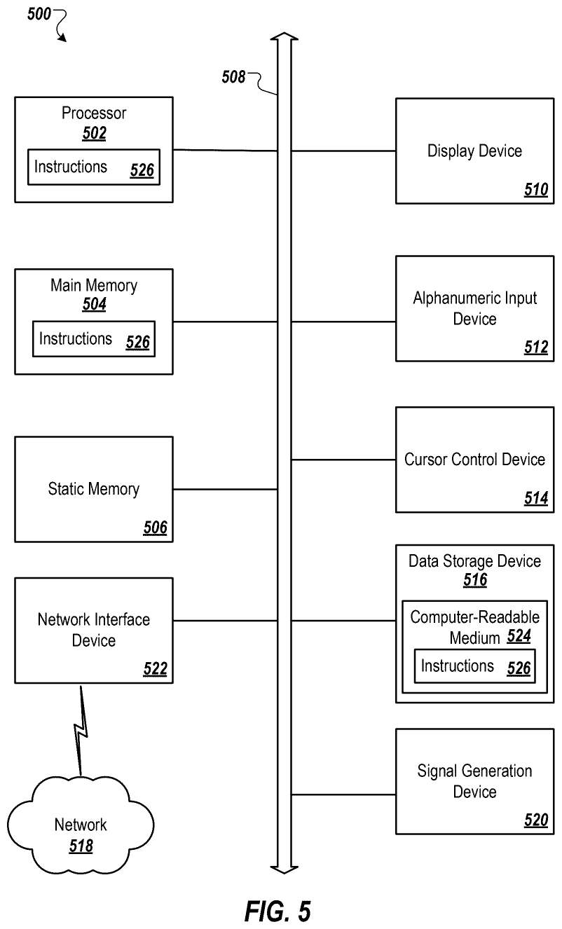

FIG. 5 illustrates an example computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 500 includes a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

The processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over the network 518 via the network interface device 522.

While the computer-readable storage medium 524 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
determining characteristics associated with a host device and a data transform accelerator;
based on the characteristics, adjusting a command field for interrupt management in a command to be transmitted from the host device to the data transform accelerator; and
obtaining transformed data from the data transform accelerator based on the command.

2. The method of claim 1, further comprising adjusting the command field to enable interrupt management for the command and adjusting a second command field to not enable interrupt management for a second command.

3. The method of claim 1, wherein in response to a particular characteristic of the characteristics satisfying a threshold, the command field is adjusted to disable the interrupt management.

4. The method of claim 1, wherein the characteristics comprise a workload associated with the data transform accelerator and a state associated with the host device and the data transform accelerator.

5. The method of claim 4, wherein the state comprises a size of data block transmitted to the data transform accelerator, a complexity of data transform operations performed by the data transform accelerator, a class of service associated with the command, a latency sensitivity associated with the class of service, a target throughput for the command, and a current bottleneck associated with the host device and the data transform accelerator.

6. The method of claim 5, wherein the target throughput is based on the class of service associated with the command.

7. The method of claim 5, wherein the size of the data block is estimated using a sliding window estimation.

8. The method of claim 5, wherein the size of the data block is determined based on a source buffer size or a destination buffer size associated with the command.

9. The method of claim 5, wherein in response to the size of the data block satisfying a threshold, the command field is adjusted to disable the interrupt management.

10. The method of claim 1, wherein in response to the command field being adjusted to be enabled, the host device obtains an interrupt notification prior to the host device obtaining the transformed data from the data transform accelerator.

11. A system, comprising:
a data transform accelerator; and
a host device, in communication with the data transform accelerator, configured to:
determine characteristics associated with the host device and the data transform accelerator;
based on the characteristics, adjust a command field for interrupt management in a command to be transmitted from the host device to the data transform accelerator; and
obtain transformed data from the data transform accelerator based on the command.

12. The system of claim 11, wherein the host device is further configured to adjust the command field to enable interrupt management for the command and adjust a second command field to not enable interrupt management for a second command.

13. The system of claim 11, wherein in response to a particular characteristic of the characteristics satisfying a threshold, the command field is adjusted to disable the interrupt management.

14. The system of claim 11, wherein the characteristics comprise a workload associated with the data transform accelerator and a state associated with the host device and the data transform accelerator.

15. The system of claim 14, wherein the state comprises a size of data block transmitted to the data transform accelerator, a complexity of data transform operations performed by the data transform accelerator, a class of service associated with the command, a latency sensitivity associated with the class of service, a target throughput for the command, and a current bottleneck associated with the host device and the data transform accelerator.

16. The system of claim 15, wherein the target throughput is based on the class of service associated with the command.

17. The system of claim 15, wherein the size of the data block is estimated using a sliding window estimation.

18. The system of claim 15, wherein the size of the data block is determined based on a source buffer size or a destination buffer size associated with the command.

19. The system of claim 15, wherein in response to the size of the data block satisfying a threshold, the command field is adjusted to disable the interrupt management.

20. The system of claim 11, wherein in response to the command field being adjusted to be enabled, the host device obtains an interrupt notification prior to the host device obtaining the transformed data from the data transform accelerator.
